(19) United States
(12) Patent Application Publication
(10) Pub. No.: US 2018/0129254 A1
(43) Pub. Date: May 10, 2018

(54) WEARABLE DEVICE PROGRAMMED TO RECORD MESSAGES AND MOMENTS IN TIME

(71) Applicant: Toyota Motor Engineering & Manufacturing North Ame rica, Inc., Erlanger, KY (US)

(72) Inventors: Rajiv Dayal, Milpitas, CA (US); Tiffany L. Chen, San Jose, CA (US); Patrick K. Ching, San Jose, CA (US); Brandon D. Northcutt, San Jose, CA (US)

(21) Appl. No.: 15/345,384

(22) Filed: Nov. 7, 2016

(51) Int. Cl. G06F 1/16

(52) U.S. Cl. CPC G06F 1/1684; G06F 1/163

(57) ABSTRACT

A wearable computing device includes a first sensor designed to detect first data of a first type. The device also includes a second sensor designed to detect second data of a second type. The device also includes an input device designed to receive user input. The device also includes a memory designed to store a plurality of triggers corresponding to the first type of data and to store the second data. The device also includes a mobile processor designed to compare the first data to the plurality of triggers as the first data is being detected. The processor is also designed to cause the memory to store the second data when the first data matches one of the plurality of triggers. The device also includes an output device configured to output the second data when the user input indicates a request to output the second data.

### BACKGROUND

### 1. Field

The present disclosure relates to wearable computing devices and, more particularly, to wearable computing devices designed to record data and output data based on detection of one or more triggers.

### 2. Description of the Related Art

Manufacturers of electronic devices have been designing and developing wearable computing devices for some time. Because such devices can be worn by a user and are relatively comfortable, they may be worn by, and interact with, the user for long periods of time. This aspect of wearable computing devices provides the opportunity for such devices to give assistance where use of other electronic devices may be undesirable. For example, it may be reasonable for a wearable computing device to periodically detect data that requires physical contact with the user because of the proximity of the wearable computing device to a body of the user. Furthermore, it may be reasonable for a wearable computing device to provide unsolicited feedback to a user at any time because the comfort of the wearable computing device may result in the user wearing it at most times.

People have been using electronic devices, such as cell phones or digital cameras, to record information for quite some time. It is relatively easy to record such information and many times can be done with the push of a button. At times, however, a user may leave an experience wishing that he had remembered to record the experience for one reason or another.

Thus, there is a need in the art for systems and methods for automatically recording data various times.

### SUMMARY

Described herein is a wearable computing device. The wearable computing device includes a first sensor designed to detect first data of a first type. The wearable computing device also includes a second sensor designed to detect second data of a second type. The wearable computing device also includes an input device designed to receive user input corresponding to a request to receive output data. The wearable computing device also includes a memory designed to store a plurality of triggers corresponding to the first type of data and to store the second data. The wearable computing device also includes a mobile processor coupled to the first sensor, the second sensor, the input device, and the memory. The processor is designed to compare the first data to the plurality of triggers stored in the memory as the first data is being detected. The processor is also designed to cause the memory to store the second data when the first data matches one of the plurality of triggers stored in the memory. The wearable computing device also includes an output device configured to output the second data stored in the memory when the user input indicates the request to output the second data.

Also described is a wearable computing device. The wearable computing device includes a U-shaped body designed to be worn around a neck of a user. The wearable computing device also includes a sensor designed to detect data corresponding to the user or an environment of the user. The wearable computing device also includes an input device attached to the U-shaped body and designed to receive user input corresponding to a request to output or transmit output data. The wearable computing device also includes a memory attached to the U-shaped body and designed to store a plurality of triggers corresponding to the user or the environment of the user. The wearable computing device also includes an output device attached to the U-shaped body and designed to output data. The wearable computing device also includes an input/output port attached to the U-shaped body and designed to transmit data to a remote device. The wearable computing device also includes a mobile processor attached to the U-shaped body and electronically coupled to the sensor, the input device, the memory, the input/output port, and the output device. The mobile processor is designed to cause the memory to store a buffer of the detected data corresponding to data previously detected by the sensor. The mobile processor is also designed to compare the detected data to the plurality of triggers stored in the memory as the data is being detected. The mobile processor is also designed to cause the memory to store the detected data along with at least some of the buffer when the first data matches one of the plurality of triggers stored in the memory. The mobile processor is also designed to at least one of cause the output device to output the stored detected data and the at least some of the buffer or to cause the input/output port to transmit the stored detected data and the at least some of the buffer to the remote device when the user input indicates the request to output or transmit the output data.

Also described is a method for storing data by a wearable computing device. The method includes detecting, by a first sensor of the wearable computing device, first data of a first type. The method also includes detecting, by a second sensor of the wearable computing device, second data of a second type. The method also includes storing, in a memory of the wearable computing device, a plurality of triggers corresponding to the first type of data. The method also includes comparing, by a mobile processor of the wearable computing device, the first data to the plurality of triggers as the first data is being detected. The method also includes storing, in the memory, the second data when the first data matches one of the plurality of triggers. The method also includes receiving, via an input device of the wearable computing device, user input corresponding to a request to receive output data. The method also includes outputting, by an output device of the wearable computing device, the second data stored in the memory when the user input indicates the request to receive the output data.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a drawing of a wearable computing device designed to be worn around a neck of a user and to automatically record various data when certain events occur according to an embodiment of the present invention;

FIG. 2 is a drawing of the wearable computing device of FIG. 1 in communication with a remote device according to an embodiment of the present invention;

FIG. 3 is a method to be performed by a wearable computing device for automatically recording a first type of data when a second type of data matches a stored trigger according to an embodiment of the present invention;

FIG. 4 is a method to be performed by a wearable computing device for automatically recording data when the same type of data matches a stored trigger according to an embodiment of the present invention;

FIG. 5 is a drawing of a user of the wearable computing device of FIG. 1 to illustrate an exemplary use of the method of FIG. 3 and the method of FIG. 4 according to an embodiment of the present invention; and

FIG. 6 is a table illustrating various “record” triggers to cause the wearable computing device of FIG. 1 to begin storing data and “output” triggers to cause the wearable computing device of FIG. 1 to output stored data according to an embodiment of the present invention.

### DETAILED DESCRIPTION

The present invention provides a wearable computing device for automatically recording data when certain events occur and for outputting the data when other events occur. The wearable computing device includes a first sensor, a second sensor, and one or more output device. A memory of the wearable computing device is used to store triggers along with detected data. The wearable computing device includes a mobile processor. When data detected by the first sensor matches a “record” trigger, the mobile processor causes the memory to begin storing data from the second sensor. When data detected by the first sensor matches an “output” trigger, the mobile processor causes the output device to output the stored data.

The wearable computing device provides several benefits and advantages such as automatically recording data when a particular event occurs. This allows a user to store important data automatically, reducing the likelihood that the user will forget to record the important data or the inconvenience to the user for having to remember to record the important data. This also provides the advantage of allowing certain health data to be recorded following an occurrence of a medical event when the user is unconscious or otherwise unaware of the medical event. The wearable computing device advantageously stores a buffer of the data to be stored so that important events that occur prior to detection of a trigger can be included with the data detected after detection of the trigger. The wearable computing device can beneficially output stored data when an “output” trigger is detected. This provides advantages such as the ability to provide reminders to Alzheimer's patients and the ability to ensure that stored data is received by an appropriate person at an appropriate time.

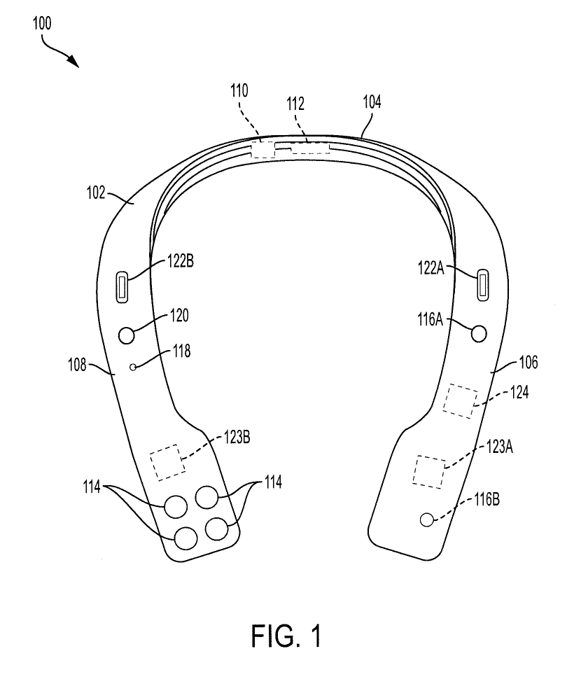

Turning to FIG. 1, a wearable computing device 100 has an outer casing, or body, 102 having a shape designed to be worn by a user. In particular, the body 102 has a neck portion 104 designed to rest against a back of a neck of the user. The body 102 also includes a first side portion 106 and a second side portion 108 each configured to extend across a shoulder of the user and to rest on a front of the user. In that regard, the wearable computing device 100 may be worn in a similar manner as a necklace. Although the disclosure is directed to the wearable computing device 100 having the U-shape, one skilled in the art will realize that the features described herein can be implemented in a wearable computing device having another shape such as eyeglasses, earpieces, mobile or handheld devices or watches.

The wearable computing device 100 includes a mobile processor 110 and a memory 112. In some embodiments, the mobile processor 110 and the memory 112 may be physically attached to the body 102, for example, positioned in a cavity defined by the neck portion 104. The memory 112 may include any memory for storing non-transitory data including instructions to be performed by the mobile processor 110.

The mobile processor 110 may receive inputs from various components of the wearable computing device 100 and may determine output data based on the various inputs. In some embodiments, the wearable computing device 100 may be designed to provide aid to individuals having physical impairments such as a visual impairment, hearing loss, or the like. For example, the wearable computing device 100 may be designed to provide navigation and social awareness features to vision-impaired individuals.

The wearable computing device 100 may include multiple components capable of receiving or detecting data. For example, the wearable computing device 100 may include one or more buttons 114, a stereo pair of cameras 116, and a microphone 118. Each of the buttons 114, the stereo pair of cameras 116, and the microphone 118 may be electrically coupled to the mobile processor 110 and physically attached to the body 102.

The buttons 114 may receive input from a user. In some embodiments, the wearable computing device 100 may include additional or alternative input devices such as a touch screen, a dial, a keypad, or the like.

The stereo pair of cameras 116 may include a first camera 116A and a second camera 116B. Each of the first camera 116A and the second camera 116B may be capable of detecting image data corresponding to an environment of the wearable computing device 100. The first camera 116A and the second camera 116B may be spaced apart by a known distance (e.g., 2-8 inches). In that regard, the mobile processor 110 may receive image data from the stereo pair of cameras 116 and may determine depth information corresponding to objects in the environment based on the received image data and the known distance between the first camera 116A and the second camera 116B. In some embodiments, the wearable computing device 100 may include one or more additional or alternative cameras. For example, the wearable computing device 100 may include a single camera instead of the stereo pair of cameras 116.

The microphone 118 may be capable of detecting audio data corresponding to the environment of the wearable computing device 100. For example, the microphone 118 may be capable of detecting speech data corresponding to speech of the user or of another person. In some embodiments, the user may provide input data to the mobile processor 110 by speaking commands that are received by the microphone 118. The microphone 118 may also be capable of detecting other sounds in the environment such as a scream, a siren from an emergency vehicle, or the like.

The wearable computing device 100 may also include a sensor 120. The sensor 120 may be electrically coupled to the mobile processor 110 and physically attached to the body 102. The sensor 120 may include one or more of a camera, a temperature sensor, an air pressure sensor, a moisture or humidity sensor, a gas detector or other chemical sensor, a sound sensor, a pH sensor, a smoke detector, a metal detector, an actinometer, an altimeter, a depth gauge, a compass, a radiation sensor, a motion detector, a light sensor or other sensor. In some embodiments, the sensor 120 may include a biological or health sensor capable of detecting data corresponding to a health metric of the user. For example, the sensor 120 may include a blood pressure sensor capable of detecting a blood pressure of the user. The sensor 120 may also include a pulse sensor capable of detecting a pulse rate of the user. The sensor 120 may also include a blood flow sensor capable of detecting an amount of blood flow through one or more veins or arteries of the user. The sensor 120 may also include a temperature sensor capable of detecting a temperature of the user. The sensor 120 may also include a breathalyzer sensor capable of detecting alcohol content within the breath of the user. The sensor 120 may also include a blood alcohol sensor capable of detecting blood alcohol content (BAC) of the user. The sensor may also include a glucose level sensor capable of detecting a glucose level of blood of the user. In some embodiments, the sensor may also include a positioning sensor such as a global positioning system (GPS) sensor or inertial measurement unit (IMU). The GPS sensor may detect location data corresponding to a location of the wearable computing device 100. The IMU may detect inertial measurement data of the wearable computing device 100.

The wearable computing device 100 may include one or more output devices including a first speaker 122A and a second speaker 122B. The speakers 122 may each be electrically coupled to the mobile processor 110 and physically attached to the body 102. Each of the speakers 122 is designed to output audio data based on an instruction from the mobile processor 110. The wearable computing device may also include a pair of vibration units 123 including a first vibration unit 123A and a second vibration unit 123B. The vibration units 123 may each include a motor and are designed to output haptic feedback such as vibrations based on an instruction from the mobile processor 110.

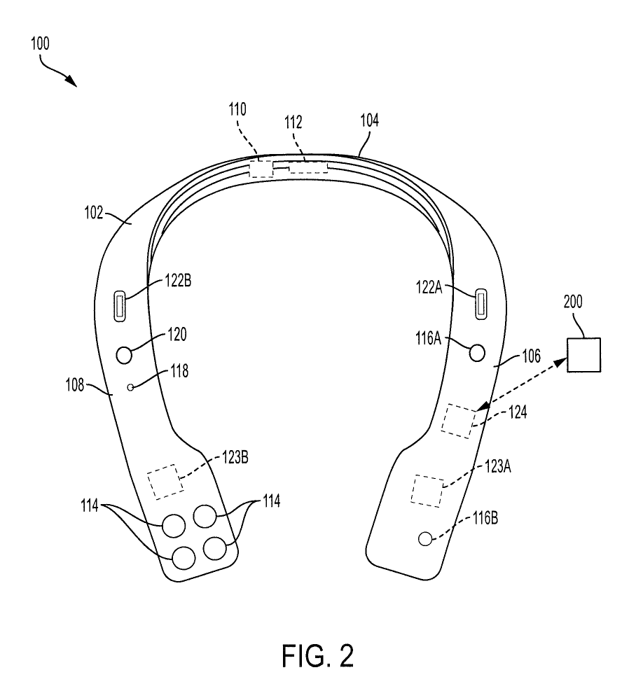

The wearable computing device 100 also includes an input/output port (I/O port) 124. Referring now to FIG. 2, the I/O port 124 is electrically coupled to the mobile processor 110 and physically attached to the body 102. The I/O port 124 may communicate with a remote device 200 that is external to the wearable computing device 100. For example, the device 200 may include another wearable computing device, a smart phone, a tablet, a laptop, a remote sensor, or any other device connected to the Internet of Things (IOT).

In some embodiments, the device 200 may include a biological or health sensor similar to those listed with respect to the sensor 120 of the wearable computing device 100. For example, the device 200 may include a heart rate sensor, a blood glucose level sensor, a temperature sensor, or the like. The device 200 may be worn on another body part of the user than the wearable computing device 100. The device 200 may be positioned at such a location that it can continuously or periodically detect data. For example, if the device 200 includes a heart rate sensor, the device 200 may be worn on a wrist of the user where it can detect a heart rate from the radial artery in the wrist.

The wearable computing device 100 may be designed to record certain activity at certain times. In particular, the wearable computing device may be programmed to detect and store data from one or more of the stereo pair of cameras 116, the microphone 118, the sensor 120, and/or the device 200 in response to a particular action occurring. In some embodiments, the action may correspond to detection of a “trigger.” That is, when data is detected that matches the trigger, the mobile processor 110 may store data detected by one or more of the stereo pair of cameras 116, the microphone 118, the sensor 120, the device 200 and/or the memory 112.

A trigger may include or be associated with an action to be occurred when the trigger is detected. For example, a trigger may correspond to a face of an individual and the action associated with the trigger may include recording audio data. One or both of the stereo pair of cameras 116 may continuously or periodically detect image data in the environment of the wearable computing device 100. The mobile processor 110 may continuously or periodically analyze the detected image data and compare the detected image data to triggers stored in the memory 112. When the detected image data is analyzed and the mobile processor 110 determines that the image data includes the face of the individual, the mobile processor 110 may cause the microphone 118 to detect audio data and cause the memory 112 to store the audio data.

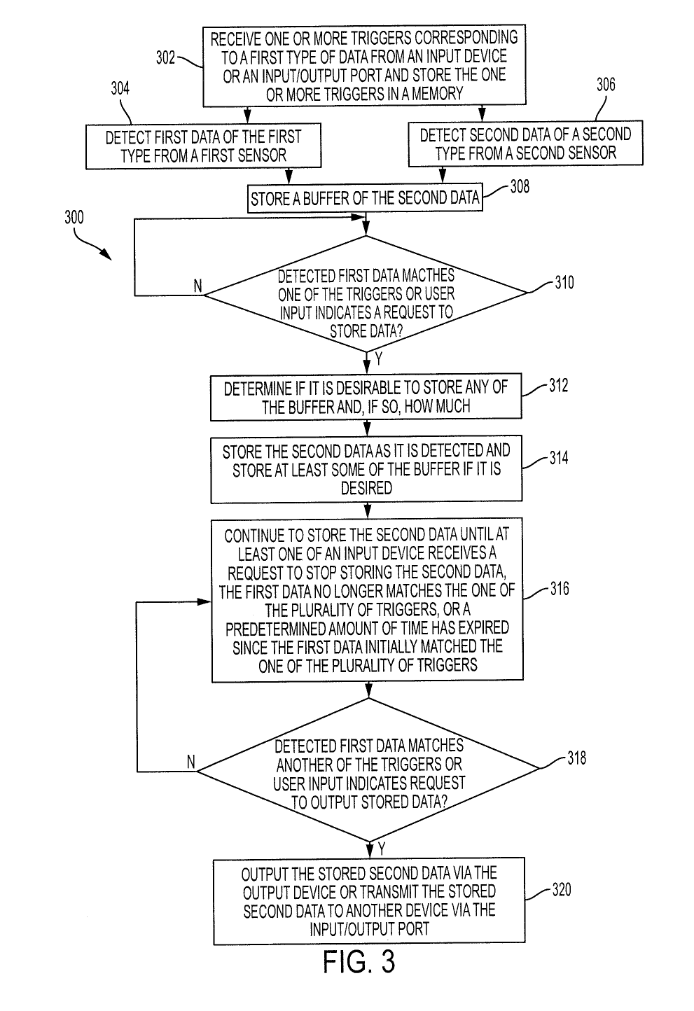

Turning now to FIG. 3, a method 300 for storing data when a trigger is detected is shown. The method 300 may be performed by components of a wearable computing device, such as the wearable computing device 100 of FIG. 1.

In block 302, a mobile processor may receive one or more triggers. The one or more triggers may correspond to a first type of data such as a date or a time, a location, a person detected by facial recognition, health attributes, inertial measurement data, other image data, audio data, or the like. The triggers may be received in various manners. In some embodiments, the wearable computing device may be programmed to have one or more triggers prior to being purchased by the end user. In some embodiments, a user may provide triggers to the wearable computing device via an input device or via an input/output port of the wearable computing device. For example, the user may use buttons, knobs, a touchscreen, a microphone, a remote device, or the like to request that certain data be stored when the blood alcohol content of the user is above a predetermined level. When the triggers are received by the wearable computing device, the mobile processor may cause the triggers to be stored in the memory.

The triggers may also include or be associated with an action to be performed when a trigger is detected. For example, a trigger may include GPS coordinates associated with a gym. A user may provide the GPS coordinates or address of the gym to the wearable computing device along with the requested action of storing a heart rate of the user when the GPS data indicates that the user is at the gym.

Most triggers are either “record” triggers or “output” triggers. “Record” triggers are typically associated with an action of storing detected data. “Output” triggers are typically associated with an action of outputting stored data.

In block 304, a first sensor of the wearable computing device may detect data of the first type. The first sensor may include any sensor of the wearable computing device such as a camera, a microphone, a blood pressure sensor, or the like. In block 306, a second sensor of the wearable computing device may detect data of a second type. The second sensor may include any sensor of the wearable computing device other than the second sensor. Furthermore, the second type of data may be different than the first type of data. For example, the first type of data may include image data and the second type of data may include audio data, the first type of data may include a time of day and the second type of data may include blood pressure data, or the like. One or both of the first data and the second data may be detected continuously or periodically.

In block 308, the mobile processor of the wearable computing device may instruct the memory to store a buffer of the second data. The buffer may correspond to storage of the second data for a predetermined amount of time. For example, the second data may be audio data and the buffer may correspond to 30 minutes of audio data, 15 minutes of audio data, 5 minutes of audio data, or the like. At any given time for a 30 minute buffer, the buffer would include the previous 30 minutes of audio data. One exception includes if the wearable computing device, or the method 300 of the wearable computing device, was powered on or initialized less than 30 minutes prior to the given time. For example, after the wearable computing device has been powered on for 15 minutes, the buffer may include 15 minutes of audio data. After the wearable computing device has been powered on for 35 minutes, however, the buffer may include the previous 30 minutes of audio data.

In block 310, the mobile processor of the wearable computing device may determine whether the second data should be stored. The mobile processor of the wearable computing device may determine that the second data should be stored either when the user input indicates that the second should be stored or when the first data matches one of the triggers.

The user input may be received via an input device of the wearable computing device or via an input/output port of the wearable computing device. For example, when a user desires for the second data to be stored, the user may depress a button of the wearable computing device or may speak a command such as “begin to store data now.” In some embodiments, the user input may be received via another device. For example, if the second data corresponds to a health metric of the user, a doctor of the user may use his or her personal device to transmit a message to the wearable computing device to begin storing the health metric.

The mobile processor of the wearable computing device may continuously or periodically analyze the detected first data and compare the detected first data to each of the plurality of “record” triggers. When the detected first data matches a “record” trigger, the mobile processor may determine to store the second data in the memory.

In some embodiments, the memory may store triggers corresponding to various types of data. For example, the memory may store some triggers corresponding to times of day, some triggers corresponding to image data, some triggers corresponding to the GPS data, or the like. In that regard, the mobile processor may continuously or periodically receive data from a clock, a camera, and a GPS sensor and may continuously or periodically compare the received data to the list of triggers in the memory.

In block 312, the mobile processor may determine whether is desirable to store any of the buffer along with the second data, and how much of the buffer to store if so. In some embodiments, the mobile processor may be programmed, either prior to being sold to an end-user or by the end-user, to never store any buffer, to always store the entire buffer, or to always store a portion of the buffer. This programming may be altered by a user based on his desires. For example, the mobile processor may be programmed by the manufacturer to never store a buffer. The user may reprogram the mobile processor to always store 5 minutes of buffer when the first data matches a particular “record” trigger.

The mobile processor may also or instead be programmed to store different amounts of buffer for different “record” triggers. For example, a first “record” trigger may correspond to image data associated with a doctor of the user, and a second “record” trigger may correspond to GPS data associated with a gym. The end user may program the mobile processor to store 5 minutes of buffer when the first “record” trigger is detected and no buffer when the second “record” trigger is detected.

In some embodiments, the user may provide input after the user requested data to be stored or after the “record” trigger has been detected. The user input may indicate whether to store the buffer and how much of the buffer to store. For example, the “record” trigger may include image data associated with a friend of the user and the data to be stored may correspond to audio data. When the mobile processor determines that detected image data matches the “record” trigger image data, the wearable computing device may output data indicating that the “record” trigger has been matched. The wearable computing device may also output a request for user feedback regarding whether to store the buffer and how much of the buffer to store.

As an example, the wearable computing device may output audio data saying “the presence of your friend has been detected. How much of the buffer would you like to store?” The user may respond by identifying whether or not to store the buffer and how much of the buffer to store.

Storing the buffer may provide advantages to the user. For example, the second data may correspond to health data, such as a heart rate of the user, and the “record” trigger may correspond to inertial measurement data indicating that the user has fallen down. The falling down of the user may be caused by a health issue such as fainting. The second data may be useful in diagnosing the health issue of the user. In that regard, it is desirable for a doctor to be able to analyze the heart rate of the user both prior to the user fainting and after the user fainting. Use of a buffer allows storage of a portion of the second data that occurred prior to detection of the “record” trigger along with data that occurred after detection of the “record” trigger.

In block 314, the mobile processor may cause the memory to store the second data as it is being detected. The second data may be stored from the time that the mobile processor determines that the first data matches the “record” trigger. The amount of the buffer to be stored that was determined in block 312 is added to the second data that is being stored. For example, if the mobile processor determined to store 10 minutes of the buffer and the “record” trigger is detected at 1:30 PM, the second data that was detected from 1:20 PM and later may be stored in the memory.

In block 316, the mobile processor may continue to cause the memory to store the second data until an event occurs indicating that no additional second data should be stored. The event may include user input indicating a request to stop storing the second data, the first data no longer matching the corresponding “record” trigger, or expiration of a predetermined amount of time since the “record” trigger was detected.

In some embodiments, the user may provide input at any time requesting that no additional second data be stored. For example, the user may request to stop storing heart rate data after the user has finished a workout, may request to stop storing audio data after a conversation with a friend or professional, or the like. The user may provide such input via the input device or a remote device. For example, the user may depress a button on the wearable computing device or a remote device, or may speak a command such as “stop storing additional audio data.”

In some embodiments, the mobile processor may be designed to continue to store additional second data until the first data no longer matches the corresponding “record” trigger. For example, when the mobile processor determines that the first data matches a “record” trigger, the mobile processor may cause the memory to store the second data and any desired buffer until the mobile processor determines that the first data no longer matches the corresponding “record” trigger.

To continue the example, the “record” trigger may correspond to image data of a friend of the user. The buffer may correspond to 10 minutes of audio data. At 1:30 PM, the mobile processor may determine that detected image data corresponds to the image data of the friend. At 1:45 PM, the mobile processor may determine that the friend is no longer detected in the image data. In that regard, the mobile processor would cause the memory to store audio data detected between 1:20 PM and 1:45 PM.

In some embodiments, the mobile processor may be programmed store data for a predetermined amount of time after the “record” trigger is no longer detected. For example, the user may program the mobile processor to record data for 5 minutes after the “record” trigger is no longer detected. Applying this rule using the above example, the mobile processor cause the memory to store audio data detected between 1:20 PM and 1:50 PM.

In some embodiments, the mobile processor may be programmed to continue to store additional second data for a predetermined amount of time after detection of the “record” trigger. For example, the “record” trigger may correspond to a sound of an explosion. It may be desirable to detect data for a period of time after an explosion has occurred. Because the sound of an explosion only lasts for a moment, it may be desirable to continue to detect data for a period of time after the explosion has occurred.

In some embodiments, the mobile processor may be programmed to store data until another trigger (a “stop recording” trigger) is detected. For example, the “record” trigger may correspond to inertial measurement data indicating that the user has fallen down, the second data may include a heart rate of the user, and the “stop recording” trigger may correspond to inertial measurement data indicating that the user has gotten back up. Thus, the mobile processor may store the heart rate of the user from the time that the inertial measurement data indicates that the user has fallen down (plus any optional buffer) until the time that the inertial measurement data indicates that the user has gotten back up.

In block 318, the mobile processor may determine when to output the stored second data. The mobile processor may determine to output the stored second data when user input indicates a request to output the data or when the detected first data or second data matches an “output” trigger.

In some embodiments, the user may request for stored data to be output at any time. For example, the user may provide input, via an input device or a remote device, requesting that stored data be output. At times, the memory may store multiple different data objects corresponding to different types of data and/or data detected at different times. In that regard, the user request may include an identifier of which data object to be output. For example, the identifier may include a type of data or a time and date that the data was detected.

In some embodiments, the user may provide a label for data as it is being stored or after it has been stored. For example, after the user finishes a conversation with a friend that has been recorded, the user may speak a command such as “this audio data is a conversation with my friend Will.” The mobile processor may then store the audio data along with the identifier “conversation with my friend Will.” To cause the wearable computing device to output the audio data, the user may provide an input request, such as a spoken command “please output the conversation with my friend Will.” In some embodiments, the user may scroll through a list of the identifiers and select the desired identifier.

In some embodiments, the mobile processor may extrapolate one or more identifiers of the stored data. Continuing the above example, the memory may have previously stored data indicating that the image data of the friend corresponds to “Will.” The mobile processor may also determine that the stored data corresponds to a conversation because the stored data is audio data and is detected while Will is present. In that regard, the mobile processor may create the identifier “conversation with Will” before, during, or after storing the audio data.

In some embodiments, the mobile processor may be programmed with the “output” triggers. The “output” trigger may be associated with the first type of data or the second type of data. Detection of an “output” trigger results in output of certain stored data.

As an example, the “record” trigger may be audio data corresponding to snoring of the user and the second data may be a blood oxygen saturation level. In that regard, the mobile processor may cause the memory to store the blood oxygen saturation level of the user when the microphone detects audio data of the user snoring. The “output” trigger may be image data of a doctor. In that regard, when the user next visits the doctor, the wearable computing device may determine to output the detected blood oxygen saturation level of the user when image data indicates that the doctor is present. This ensures that the data will not be forgotten and will be provided to the doctor. In some embodiments, the “output” trigger may include a time of day or a particular location.

In block 320, the mobile processor may cause an output device of the wearable computing device to output the stored second data or may cause the stored second data to be transmitted to a remote device via an input/output port.

The method 300 may be used for dementia assistance, security purposes, posterity, entertainment, or the like. For example, the method 300 may be used by a person suffering from Alzheimer's disease. The user may provide a request in block 410 to store audio data when a user is checking in to a hotel. The audio data may include a predetermined message such as “you are in room 410.” The user may provide an “output” trigger to output the predetermined message when GPS data indicates that the user has entered the hotel. By programming the mobile processor in this way, the user will be reminded of his hotel room number each time the user arrives at the hotel.

Another example that may be useful for a user suffering from Alzheimer's disease is a reminder to take pills. Again, the user may provide a request in block 410 to store audio data when the user receives a new prescription. The audio data may include a predetermined message such as “take your new drug now.” The user may provide an “output” trigger to output the predetermined message at the times in which the user is supposed to take the new prescription. For example, the doctor may provide instructions such as to take the prescription in the morning and in the evening. Either the user or the mobile processor may select times that correspond to the morning and the evening, such as 9 AM and 6 PM. The “output” trigger may correspond to a time of 9 AM and a time of 6 PM. In that regard, the wearable computing device will output the message “take your new drug now” at 9 AM and 6 PM.

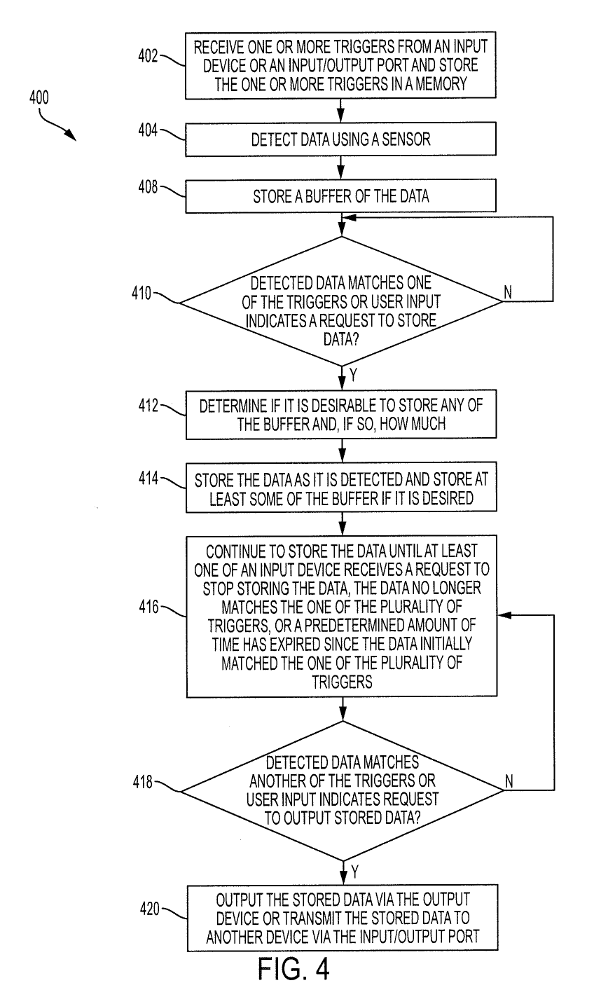

Turning now to FIG. 4, another method 400 is shown for storing data when a “record” trigger is detected. The method 400 is similar to the method 300 with the exception that the trigger data and the stored data are of the same type. Blocks 402 through 420 of FIG. 4 are similar to blocks 302 through 320 of FIG. 3. In block 404, however, data is detected using a single sensor, and a second type of data may not be detected.

The method 400 may be preferable to the method 300 when it is desirable to store data that also triggers storage of the data. For example, for health reasons, it may be desirable to store a blood pressure of a user when the blood pressure is greater than a predetermined value. This information may be used by a doctor to diagnose or determine treatment for the user. In that regard, the user or the doctor may program a trigger for the mobile processor to cause the memory to store the blood pressure of the user when either of the systolic blood pressure is greater than 145 or the diastolic blood pressure is greater than 95. In that regard, the mobile processor may cause the memory to store the blood pressure of the user when the data detected by the blood pressure sensor indicates that either the systolic blood pressure is greater than 140 or the diastolic blood pressure is greater than 95.

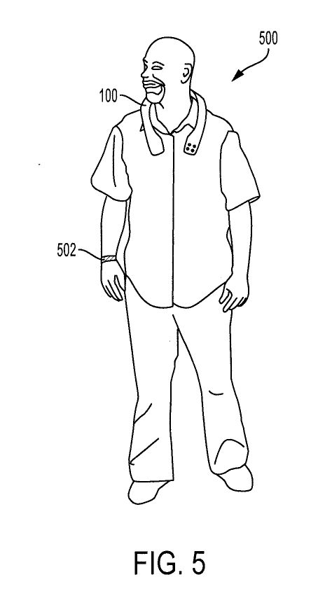

Turning now to FIGS. 1, 5, and 6, exemplary uses of the methods 300 and 400 of FIGS. 3 and 4 are shown. A user 500 is wearing the wearable computing device 100. The user 500 is also wearing a heart rate sensor 502. The memory 112 may store a table 600 of various triggers. The table 600 may include two “record” triggers and two “output” triggers. The user 500 may wish to store his heart rate while he is working out for personal reasons, and a doctor may wish to analyze the heart rate of the user when the heart rate is above 120 beats per minute (bpm) for diagnostic purposes.

In that regard, the first “record” trigger corresponds to GPS data indicating that the user is at the gym, and the second “record” trigger corresponds to heart rate data indicating that the heart rate of the user 500 is above 120 bpm. Similarly, the first “output” trigger corresponds to location data indicating that the user 500 is leaving the gym, and the other “output” trigger corresponds to image data of a doctor of the user 500.

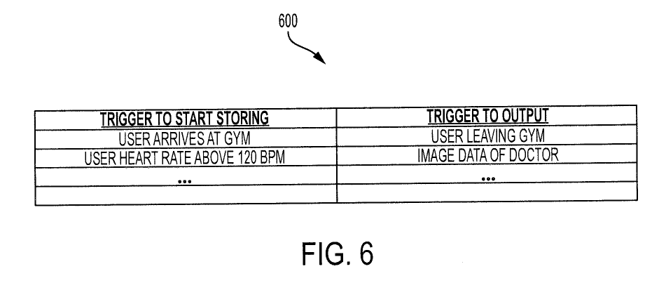

As shown in FIG. 6, the “record” triggers and the “output” triggers may be associated with each other such that data detected in response to detection of one “record” trigger is only output in response to detection of one “output” trigger. In some embodiments, data detected in response to one “record” trigger may be output in response to any of multiple “output” triggers, and vice versa. In some embodiments, the “record” triggers and the “output” triggers may not be associated with each other. In that regard, data detected in response to detection of any “record” trigger may be output in response to detection of any “output” trigger.

The heart rate sensor 502 may continuously or periodically detect the heart rate of the user 500. The mobile processor 110 of the wearable computing device 100 may continuously or periodically analyze the detected location data from a GPS sensor to determine whether the user 500 is at the gym. The mobile processor 110 may cause the memory 112 store the heart rate of the user from the time the user arrives at the gym until the user leaves the gym.

When the GPS data indicates that the user has left the gym, the mobile processor 110 may also cause the speakers 122 and/or the vibration units 123 to output data indicating the detected heart rate of the user that was detected throughout the workout.

The mobile processor 110 may also continuously or periodically analyze the detected heart rate of the user. When the mobile processor 110 determines that the heart rate of the user has reached or exceeded 120 bpm, the mobile processor 110 may cause the memory 112 to begin storing the detected heart rate of the user. This data may be stored until the heart rate of the user has again reached or dropped below 120 bpm.

When the user next visit his doctor, the mobile processor 110 may determine that detected image data corresponds to image data of the doctor. In response to this determination, the mobile processor 110 may cause the speakers 122 or the vibration units 123 to output the stored heart rate data.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A wearable computing device comprising:
a first sensor configured to detect first data of a first type;
a second sensor configured to detect second data of a second type;
an input device configured to receive user input corresponding to a request to receive output data;
a memory configured to store a plurality of triggers corresponding to the first type of data and to store the second data;
a mobile processor coupled to the first sensor, the second sensor, the input device, and the memory and configured to:
compare the first data to the plurality of triggers stored in the memory as the first data is being detected, and
cause the memory to store the second data when the first data matches one of the plurality of triggers stored in the memory; and
an output device configured to output the second data stored in the memory when the user input indicates the request to output the second data.

2. The wearable computing device of claim 1 wherein the input device is further configured to receive user input defining at least some of the plurality of triggers and the mobile processor is further configure to store the at least some of the plurality of triggers in the memory in response to the input device receiving the user input defining the at least some of the plurality of triggers.

3. The wearable computing device of claim 1 wherein the mobile processor is configured to cause the memory to store the second data until at least one of:
the input device receives user input corresponding to a request to stop storing the second data;
the first data fails to match the one of the plurality of triggers; or
a predetermined amount of time has expired since the first data initially matched the one of the plurality of triggers.

4. The wearable computing device of claim 1 wherein the input device is further configured to receive input corresponding to a request to store the second data and wherein the mobile processor is further configured to cause the memory to store the second data when the input device receives the input corresponding to the request to store the second data.

5. The wearable computing device of claim 4 wherein the mobile processor is further configured to cause the memory to store a buffer of the second data corresponding to previously detected second data and wherein the mobile processor is further configured to cause the memory to store at least some of the buffer along with the second data when the input device receives the input corresponding to the request to store the second data.

6. The wearable computing device of claim 1 wherein the mobile processor is further configured to cause the memory to store a buffer of the second data corresponding to previously detected second data and wherein the mobile processor is further configured to cause the memory to store at least some of the buffer along with the second data when the first data matches the one of the plurality of triggers stored in the memory.

7. The wearable computing device of claim 1 wherein the mobile processor is further configured to cause the output device to output the second data stored in the memory when the first data matches another of the plurality of triggers.

8. The wearable computing device of claim 7 wherein the first sensor includes a clock configured to detect a current time and wherein the another of the plurality of triggers includes a predetermined time of day such that the second data is output when the current time of day matches the predetermined time of day.

9. A wearable computing device comprising:
a U-shaped body configured to be worn around a neck of a user;
a sensor configured to detect data corresponding to the user or an environment of the user;
an input device attached to the U-shaped body and configured to receive user input corresponding to a request to output or transmit output data;
a memory attached to the U-shaped body and configured to store a plurality of triggers corresponding to the user or the environment of the user;
an output device attached to the U-shaped body and configured to output data;
an input/output port attached to the U-shaped body and configured to transmit data to a remote device; and
a mobile processor attached to the U-shaped body and electronically coupled to the sensor, the input device, the memory, the input/output port, and the output device and configured to:
cause the memory to store a buffer of the detected data corresponding to data previously detected by the sensor,
compare the detected data to the plurality of triggers stored in the memory as the data is being detected,
cause the memory to store the detected data along with at least some of the buffer when the first data matches one of the plurality of triggers stored in the memory, and
at least one of cause the output device to output the stored detected data and the at least some of the buffer or cause the input/output port to transmit the stored detected data and the at least some of the buffer to the remote device when the user input indicates the request to output or transmit the output data.

10. The wearable computing device of claim 9 wherein the input device is further configured to receive user input corresponding to a request to store the detected data and wherein the mobile processor is further configured to cause the memory to store the detected data when the user input corresponds to the request to store the detected data.

11. The wearable computing device of claim 9 wherein the input device is further configured to receive user input defining at least some of the plurality of triggers and the mobile processor is further configure to store the at least some of the plurality of triggers in the memory in response to the input device receiving the user input defining the at least some of the plurality of triggers.

12. The wearable computing device of claim 9 wherein the mobile processor is configured to cause the memory to store the detected data until at least one of:
the input device receives user input corresponding to a request to stop storing the detected data;
the detected data fails to match the one of the plurality of triggers; or
a predetermined amount of time has expired since the detected data initially matched the one of the plurality of triggers.

13. The wearable computing device of claim 9 wherein the sensor includes a health sensor configured to detect a health metric of the user and wherein the one of the plurality of triggers is a predetermined value of the health metric of the user.

14. The wearable computing device of claim 9 wherein the sensor includes an inertial measurement unit (IMU) configured to detect inertial measurement data of the wearable computing device and wherein the one of the plurality of triggers is a predetermined value of the inertial measurement of the wearable computing device.

15. The wearable computing device of claim 9 wherein the sensor includes a camera configured to detect image data and wherein the one of the plurality of triggers is image data corresponding to a face of a person or an object.

16. The wearable computing device of claim 9 wherein the sensor is remote from the wearable computing device and includes a sensor input/output port configured to communicate with the input/output port of the wearable computing device such that the mobile processor can receive the detected data via the sensor input/output port and the input/output port of the wearable computing device.

17. A method for storing data by a wearable computing device comprising:
detecting, by a first sensor of the wearable computing device, first data of a first type;
detecting, by a second sensor of the wearable computing device, second data of a second type;
storing, in a memory of the wearable computing device, a plurality of triggers corresponding to the first type of data;
comparing, by a mobile processor of the wearable computing device, the first data to the plurality of triggers as the first data is being detected;
storing, in the memory, the second data when the first data matches one of the plurality of triggers;
receiving, via an input device of the wearable computing device, user input corresponding to a request to receive output data; and
outputting, by an output device of the wearable computing device, the second data stored in the memory when the user input indicates the request to receive the output data.

18. The method of claim 17 further comprising:
receiving, via the input device, user input defining at least some of the plurality of triggers; and
storing, in the memory, the at least some of the plurality of triggers when the user input defining the at least some of the plurality of triggers is received.

19. The method of claim 17 further comprising:
receiving, via the input device, user input corresponding to a request to store the second data; and
storing, in the memory, the second data when the user input corresponding to the request to store the second data is received.

20. The method of claim 17 further comprising:
detecting, by the first sensor, a current time of day;
outputting, via the output device, the second data stored in the memory when the current time of day matches a predetermined time of day.
